(19) United States
(12) Patent Application Publication
(10) Pub. No.: US 2015/0308930 A1
(43) Pub. Date: Oct. 29, 2015

(54) PARTICLE MEASURING DEVICE AND METHOD FOR OPERATING THE PARTICLE MEASURING DEVICE

(71) Applicant: AVL LIST GMBH, GRAZ (AT)

(72) Inventors: CHRISTOS BERGER, GRAZ (AT); SLAVEN DODIG, GRAZ (AT); MARTIN AUGUSTIN, GRAZ (AT); ROBERT DIEWALD, GRAZ (AT); GÜNTER WINKLER, GRAZ (AT); VERENA VESCOLI, GRAZ (AT); MICHAEL KRÜGER, HEIDESHEIM (DE)

(73) Assignee: AVL LIST GMBH, GRAZ (AT)

(21) Appl. No.: 14/695,756

(22) Filed: Apr. 24, 2015

(30) Foreign Application Priority Data
Apr. 25, 2014 (AT) A 50305/2014

(51) Int. Cl. G01N 1/22

(52) U.S. Cl. CPC G01N 1/2252

(57) ABSTRACT

In order to effectively protect a particle measuring device (8) against temperatures that are too high and/or too low, it is provided that the temperature (T) of the sample gas is measured upstream of a first temperature-sensitive sample gas processing or sample gas measuring device (20, 21, 22, 42) in the particle measuring device (8) and that the measured temperature (T) is compared with a first and/or second limit value (Tₒ, Tᵤ) and that the particle measuring device (8) is switched into a safe mode if the measured temperature (T) exceeds the first limit value (Tₒ) or falls below the second limit value (Tᵤ).

The present invention relates to a particle measuring device and to a method for operating the particle measuring device comprising a number of sample gas processing and/or sample gas measuring devices, to which particle measuring device a particle-laden sample gas is fed at a temperature.

A particle measuring device, such as a particle counter, for determining characteristic values of a particle-laden gas flow, such as the concentration of solid particles, the size distribution of solid particles, the mass of solid particles, the specific surface area etc., is usually fed with diluted particle-laden sample gas. For this purpose, the particle-laden sample gas, e.g. exhaust gas of an internal combustion engine, is extracted from a gas flow, for example from the exhaust pipe of a vehicle, and is fed to the particle measuring device via a sample gas line, which can also be heated. Various processing units or measuring units can be provided in the particle measuring device. For example, a dilution unit is often arranged on the inlet side, in which the particle-laden sample gas is diluted in a certain ratio with a substantially particle-free dilution gas, such as cleaned, dried and filtered air. Such a dilution unit in the form of a rotating disc diluter is known, e.g., from EP 2 025 979 B1. Another known dilution unit is a so-called dilution tunnel as is known, e.g., from EP 1 367 379 B1. By diluting, the sample gas is usually also cooled by the cool dilution gas so that the subsequent components of the particle measuring device are protected against excessively high temperatures.

However, sample gases having different temperatures can be fed to the inlet of the particle measuring device. In particular raw exhaust gas extracted from the exhaust pipe of an internal combustion engine can have temperatures within a very wide temperature range. In order to protect the particle measuring device against the high temperatures of the sample gas, temperature-controlled sample gas lines of a certain length are used. For example, a stainless steel pipe heated to 150° C. and having a length of 50 cm between the sampling point and the particle measuring device is provided to prevent excessive temperatures at the inlet of the particle measuring device. However, as experience shows, it is nevertheless possible in normal operation that the sample gas at the inlet of the particle measuring device can have a higher temperature for a short time. For design and material reasons, various components of the particle measuring device must not be exposed to a temperature higher than a given maximum. If this temperature limit is exceeded, in particular for a longer period of time, this can result in damage to the particle measuring device or even in the destruction thereof, and in any case in failure of the particle measuring device.

On the other hand, sample gas temperatures that are too low, in particular temperatures below the respective dew point, are also problematic since this can result in condensation within the particle measuring device. The resulting condensate can adversely affect the function of the particle measuring device or components thereof, or can even damage or destroy the particle measuring device.

It is therefore an object of the present invention to propose a particle measuring device and a method by means of which a particle measuring device can be effectively protected against temperatures that are too high and/or too low.

This object is achieved according to the invention in that the temperature of the sample gas is measured upstream of a first temperature-sensitive sample gas processing or sample gas measuring device in the particle measuring device and that the measured temperature is compared with a first and/or second limit value, and that the particle measuring device is switched into a safe mode if the measured temperature exceeds the first limit value or falls below the second limit value. In this manner, temperature-sensitive devices in the particle measuring device can be effectively protected against temperatures that are too high or too low since the particle measuring device is switched into the safe mode as soon as the temperatures leaves the safe temperature range.

In order to prevent switching over into the safe mode in the case of short, strong temperature fluctuations, it can be provided to switch the particle measuring device into the safe mode if the measured temperature exceeds the first limit value or falls below the second limit value for a defined period of time. This is based on the idea that short-term high temperatures can still be unproblematic even when they exceed an upper limit value. Damage would have to be expected only if the excessive temperature prevails for too long, which is prevented thereby.

It is important that the temperature sensor is arranged upstream of the first temperature-sensitive sample gas processing or sample gas measuring device in the particle measuring device in order to effectively protect same against excessively high temperatures. The temperature sensor detects the temperature of the sample gas, and a control unit compares the detected temperature with a first and/or second limit value; the control unit switches the particle measuring device into a safe mode if the measured temperature exceeds the first limit value or falls below the second limit value. For this purpose, the temperature sensor can be arranged in an inlet line at the inlet of the particle measuring device, in a bypass line in the particle measuring device or in a bypass line around the particle measuring device.

In a variant of the invention, a bypass line in the particle measuring device branches off upstream of the particle measuring device or upstream of the first temperature-sensitive sample gas processing or sample gas measuring device, and the temperature sensor is arranged in the bypass line.

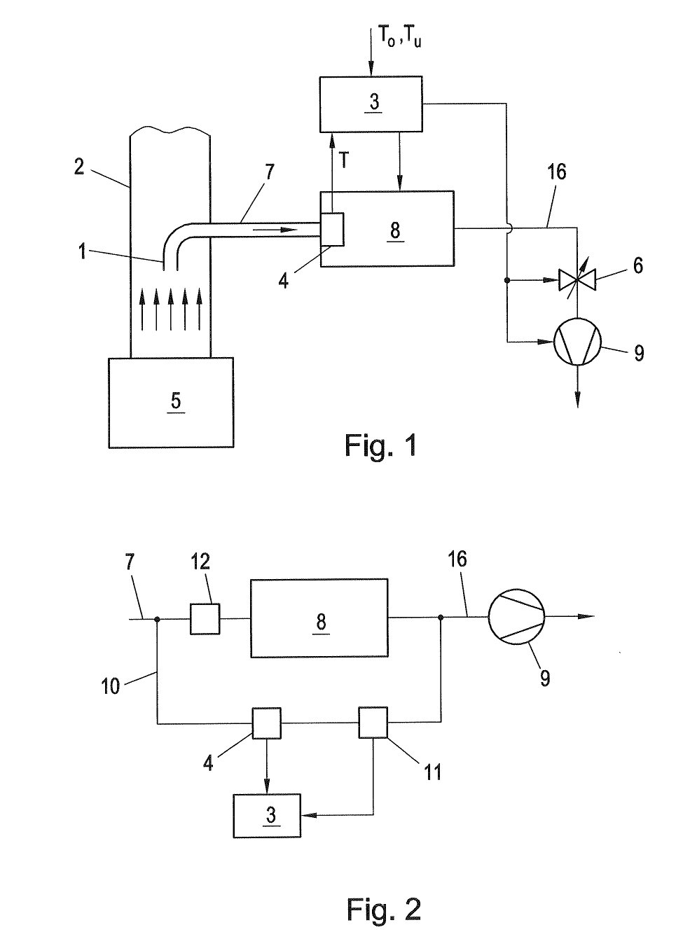

The present invention is explained in more detail below with reference to FIGS. 1 to 4, which show advantageous configurations of the invention in an exemplary, schematically and non-limiting manner. In the figures:

FIG. 1 shows an arrangement for determining characteristic values of a particle-laden gas flow by means of a particle measuring device,

FIG. 2 shows an arrangement with bypass line around the particle measuring device,

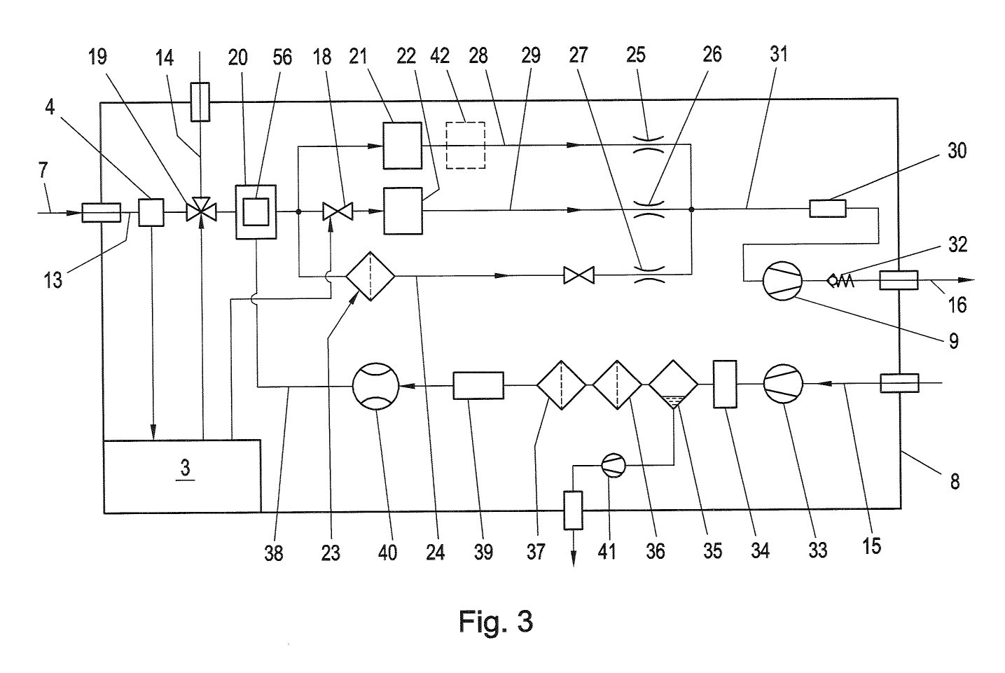

FIG. 3 shows an advantageous configuration of a particle measuring device according to the invention, and

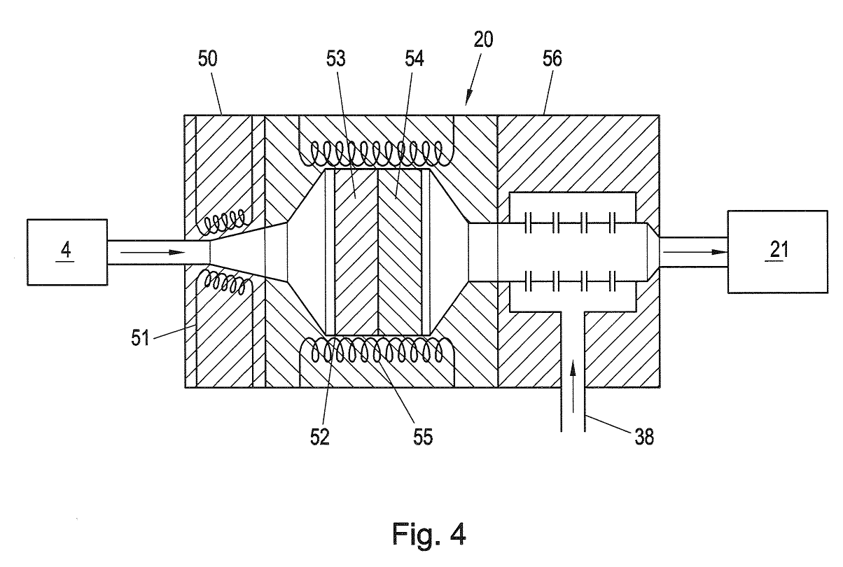

FIG. 4 shows an exemplary embodiment for a sample gas conditioning device in the particle measuring device.

In the arrangement according to FIG. 1, particle-laden sample gas (here exhaust gas) is extracted from the exhaust pipe 2 of an internal combustion engine 5 by means of an exhaust gas sampling probe 1 and is fed to a particle measuring device 8 via a sample gas line 7. A suction pump 9 is provided downstream of the particle measuring device 8 to ensure a certain volume flow through the particle measuring device 8. Likewise, a volume flow control unit 6 can additionally be provided upstream or downstream of the suction pump 9. A control unit 3 controls the functions of the particle measuring device 8 and optionally also of the suction pump 9 and the volume flow control unit 6, as indicated in FIG. 1. A temperature sensor 4 which delivers the detected temperature of the fed sample gas to the control unit 3 is arranged at the inlet of the particle measuring device 8, e.g. in an inlet line 13 of the particle measuring device 8. The temperature sensor 4 is to be arranged such that it is arranged upstream of the first temperature-sensitive sample gas processing or sample gas measuring device in the particle measuring device 8. Of course, sample gas processing or sample gas measuring devices that are not temperature-sensitive could be arranged upstream of the temperature sensor 4. However, for the function of temperature monitoring, the temperature sensor 4 could, of course, also be arranged in the sample gas line 7 outside of the particle measuring device 8.

A needle-shaped thermocouple is preferably used as a temperature sensor 4 to influence the sample gas flow as little as possible, in particular to prevent introduction of undesirable turbulences into the sample gas flow and to ensure, due to the low mass of the temperature sensor 4, a rapid response behavior of the temperature measurement, which is important for the ability to detect short-term temperature fluctuations.

In the control unit 3, the temperature T of the fed sample gas is monitored with regard to exceeding and/or falling below temperature limit values Tₒ, Tᵤ. The temperature limit values Tₒ, Tᵤ can be specified to be fix or can also be specified externally. If the temperature T exceeds or falls below the respective temperature limit value Tₒ, Tᵤ, the particle measuring device 8 is switched into a safe mode to prevent components of the particle measuring device 8 from being damaged by temperature T that is too high or too low. The safe mode could comprise closing a switching valve on the inlet side or closing individual measuring channels in the particle measuring device 8, for example. Switching over by a switching valve to measuring the ambient air could also be provided as a safe mode. It would also be conceivable to reduce or completely stop the volume flow through the particle measuring device 8 via the suction pump 9 and/or the volume flow control unit 6. Another possibility for a safe mode is, of course, to completely switch off the particle measuring device 8. Parallel to this it is, of course, also possible to output corresponding warning signals, e.g. acoustically or on a display.

Instead of evaluating the current temperature T, it could also be monitored in the control unit 3 whether the temperature T lies above or below the respective temperature limit value for a certain defined period of time. Very short-term high temperatures T can still be acceptable for the particle measuring device 8. Only if the temperature T lies above the limit value for a period of time, the particle measuring device 8 could be switched into the safe mode.

In the exemplary embodiment according to FIG. 2, the temperature sensor 4 is not arranged in the particle measuring device 8, but is arranged in a bypass line 10 that is guided around the particle measuring device 8. The bypass line 10 branches off upstream of the particle measuring device 8 and ends again in the outlet line 16 downstream of the particle measuring device 8. After the bypass line 10 branches off upstream of the particle measuring device 8, a temperature sensor 4 arranged in the bypass line 10 also measures, of course, the temperature upstream of the particle measuring device 8, or a temperature sensor 4 arranged in such a manner is also arranged upstream of the particle measuring device 8 and therefore also upstream of the first temperature-sensitive sample gas processing or sample gas measuring device in the particle measuring device 8.

However, the bypass line 10 could, of course, also be arranged in the particle measuring device 8, wherein in this case, the bypass line 10 has to branch off upstream of the first temperature-sensitive sample gas processing or sample gas measuring device in the particle measuring device 8, for example upstream of a sample gas conditioning device 20, as described below.

Other sensors 11, 12, e.g. a pressure sensor or a humidity sensor which can also deliver their measured values to the control unit 3, could also be arranged in the bypass line 10 and/or upstream of or in the particle measuring device 8. Thus, the control unit 3 could also use further sensor signals for monitoring or protecting the particle measuring device 8.

FIG. 3 schematically illustrates a possible configuration of a particle measuring device 8. A sample gas line 7 is connected to the particle measuring device 8 and ends in an inlet line 13 of the particle measuring device 8. A number of sample gas processing and sample gas measuring devices are arranged in the particle measuring device 8. On the inlet side, the inlet line 13 ends in a sample gas conditioning device 20, which processes the fed sample gas in a suitable manner. Upstream of the sample gas processing device 20, a switching valve 19 can be arranged by means of which the particle measuring device 8 can be shut off under the control of the control unit 3 so that the sample gas can no longer flow through. As an alternative, the switching valve 19 could also be switched over to feeding outside air via an air line 14.

Here, the particle measuring device 8 is configured in a two-channel manner with two measuring channels (possibly redundant) in that the fed sample gas flow in the particle measuring device 8 is divided between two measuring lines 28, 29 being arranged in parallel and having sample gas measuring devices 21, 22 arranged therein, such as scattered light measuring devices, opacimeters, particle counters, aerosol electrometers etc. Of course, more than two measuring channels or only a single measuring channel can also be provided. It is also conceivable to arrange two measuring devices 21, 42 one behind the other in a measuring line 28, 29, as indicated in FIG. 3. When using a plurality of sample gas measuring devices 21, 22, 42, the sensitivity of the particle measuring device 8 can be increased by using sample gas measuring devices 21, 22, 42 having different resolutions and/or measuring ranges. A shut-off valve 18 can also be arranged in a measuring line 29 so as to shut off an individual measuring channel under the control of the control unit 3.

In order to be able to adjust the volume flow through the individual sample gas measuring devices 21, 22, 42 in a simple manner, a measuring device bypass line 24 which includes a filter unit 23 here and is arranged parallel to the measuring lines 28, 29 can be provided. A critical orifice 25, 26, 27 can additionally be arranged in each of the lines, which likewise serves for regulating the volume flows in the individual lines 24, 28, 29. Downstream of the sample gas measuring devices 21, 22, 42, the individual lines 24, 28, 29 are combined again into one outlet line 31 in which a pulsation damper 30 can be arranged. Furthermore, the suction pump 9 can also be arranged in the outlet line 31. Moreover, a safety valve 32 can further be provided on the outlet side so as to prevent the surrounding air from flowing back into the measuring channels of the particle measuring device 8.

If, e.g., the sample gas measuring device 22 would be the first temperature-sensitive sample gas measuring device viewed in the flow direction, the temperature sensor 4 could also be arranged in the measuring device bypass line 24, which then serves at the same time as bypass line 10 for the temperature sensor 4.

A dilution stage 56, in which the extracted exhaust gas is diluted with gas or preferably with particle-free air, can also be provided in the exhaust gas processing device 20, as described in detail below with reference to FIG. 4. In order to provide the pure air required for this, an air processing unit can also be provided in the particle measuring device 8, as illustrated in FIG. 3 by way of example. Here, ambient air is suctioned by a dilution air pump 33 via a dilution air suction line 15, is cooled in a gas cooler 34, dried in a condensate separator 35 and filtered in filter units 36, 37. The air processed in such a manner can then be extracted and can be fed to the exhaust gas processing device 20 via a dilution air line 38. A pulsation damper 39 and a mass flow regulation device 40 can also be arranged in the dilution air line 38. Separated condensation water can be discharged from the particle measuring device 8 by means of a condensate pump 41.

In the exemplary exhaust gas processing device 20, as illustrated in FIG. 4, e.g., a pre-heating section 50 is provided in which the temperature of the fed exhaust gas is pre-controlled by means of the heating element 51. Also, volatile exhaust gas constituents are transferred into the gas phase in the pre-heating element 50. Subsequent thereto, a catalyst 52 is connected, as described, e.g., in AT 13 239 U1, in which volatile exhaust gas constituents are removed from the exhaust gas. The catalyst 52 comprises an oxidation catalyst 53 in which volatile organic exhaust gas constituents are combusted, and a sulfur trap 54 in which volatile sulfatic particles are bound and thus are removed from the exhaust gas. The temperature of the catalyst 52 can preferably be controlled by means of a heating device 55, e.g. under control of the control unit 3. A dilution stage 56 in which the cleaned sample gas flow is diluted with pure air is connected downstream of the catalyst 52. Here, the dilution stage 56 is configured, e.g., as a porous diluter, as described in EP 2 264 423 A2. Of course, other embodiments of the dilution stage 56 are also conceivable, e.g. as a rotating disc diluter, as described in EP 2 025 979 B1, or as a dilution tunnel known per se. An embodiment of the exhaust gas processing device 20 without downstream dilution stage 56 or only with a dilution stage 56 (without pre-heating section 50 and without catalyst 52) is also conceivable.

1. A method for operating a particle measuring device (8), comprising a number of sample gas processing and/or sample gas measuring devices (20, 21, 22, 42), to which particle measuring device particle-laden sample gas at a temperature (T) is fed, characterized in that the temperature (T) of the sample gas is measured upstream of a first temperature-sensitive sample gas processing or sample gas measuring device (20, 21, 22, 42) in the particle measuring device (8), and that the measured temperature (T) is compared with a first and/or second limit value (Tₒ, Tᵤ) and that the particle measuring device (8) is switched into a safe mode if the measured temperature (T) exceeds the first limit value (Tₒ) or falls below the second limit value (Tᵤ).

2. The method according to claim 1, characterized in that the particle measuring device (8) is switched into the safe mode if the measured temperature (T) exceeds the first limit value (Tₒ) or falls below the second limit value (Tᵤ) for a defined period of time.

3. A particle measuring device comprising a number of sample gas processing and/or sample gas measuring devices (20, 21, 22, 42) and a temperature sensor (4) which is arranged upstream of a first temperature-sensitive sample gas processing or sample gas measuring device (20, 21, 22, 42) in the particle measuring device (8) and which detects the temperature (T) of the sample gas, and a control unit (3) compares the detected temperature (T) with a first and/or second limit value (Tₒ, Tᵤ), and the control unit (3) switches the particle measuring device (8) into a safe mode if the measured temperature (T) exceeds the first limit value (Tₒ) or falls below the second limit value (Tᵤ).

4. The particle measuring device according to claim 3, characterized in that the temperature sensor (4) is arranged in an inlet line (13) at the inlet of the particle measuring device (8).

5. The particle measuring device according to claim 3, characterized in that a bypass line (10) branches off upstream of the first temperature-sensitive sample gas processing or sample gas measuring device (20, 21, 22, 42) in the particle measuring device (8) and that the temperature sensor (4) is arranged in the bypass line (10).

6. The particle measuring device according to claim 3, characterized in that a bypass line (10) branches off upstream of the particle measuring device (8) and that the temperature sensor (4) is arranged in the bypass line (10).
